(19) United States
(12) Patent Application Publication
(10) Pub. No.: US 2025/0174756 A1
(43) Pub. Date: May 29, 2025

(54) BATTERY SYSTEM AND HEAT TRANSFER UNIT FOR BATTERY SYSTEM

(71) Applicant: SAMSUNG SDI CO., LTD., Yongin-si (KR)

(72) Inventors: Marton NEMES, Seiersberg-Pirka (AT); Gernot KRABERGER, Graz (AT)

(21) Appl. No.: 18/795,894

(22) Filed: Aug. 6, 2024

(30) Foreign Application Priority Data
Nov. 29, 2023 (EP) 23213121.9

(51) Int. Cl. H01M 10/6555; H01M 10/647; H01M 10/653; H01M 10/658; H01M 50/209; H01M 50/293

(52) U.S. Cl. CPC H01M 10/6555; H01M 10/647; H01M 10/653; H01M 10/658; H01M 50/209; H01M 50/293

(57) ABSTRACT

A battery system including: a battery cell stack including a plurality of battery cells and a plurality of thermally isolating cell spacers between the plurality of battery cells; and a heat transfer unit on at least one side of the battery cell stack, the heat transfer unit including a first heat transfer element and a second heat transfer element, wherein the first heat transfer element and the second heat transfer element are thermally isolated from each other. The first heat transfer element contacts at least one of the battery cells in an even row of the battery cell stack and the second heat transfer element contacts at least one of the battery cells in an odd row of the battery cell stack.

### CROSS-REFERENCE TO RELATED APPLICATION

The present application claims priority to and the benefit of European Patent Application No. 23213121.9, filed on Nov. 29, 2023, in the European Patent Office, the entire disclosure of which is incorporated herein by reference.

### BACKGROUND

### 1. Field

Aspects of embodiments of the present disclosure relate to a battery system and a heat transfer unit for a battery system.

### 2. Description of the Related Art

Recently, vehicles for transportation of goods and peoples have been developed that use electric power as a source for motion. An electric vehicle is an automobile that is propelled by an electric motor using energy stored in rechargeable batteries. An electric vehicle may be powered by batteries or may be a form of hybrid vehicle powered by for example a gasoline generator or a hydrogen fuel power cell. A hybrid vehicle may include a combination of an electric motor and a combustion engine. Generally, an electric-vehicle battery (“EVB” or traction battery) is a battery used to power the propulsion of vehicles (e.g., battery electric vehicles “BEVs” and/or the like). Electric-vehicle batteries may be different from starting, lighting, and ignition batteries in that they are designed to provide power for sustained periods of time. A rechargeable (or secondary) battery differs from a primary battery in that it is designed to be repeatedly charged and discharged, while the latter is designed to provide an irreversible conversion of chemical to electrical energy. Low-capacity rechargeable batteries are used as power supplies for small electronic devices, such as cellular phones, notebook computers and camcorders, while high-capacity rechargeable batteries are used as power supplies for vehicles (e.g., electric and hybrid vehicles and the like).

Generally, rechargeable batteries include an electrode assembly including a positive electrode, a negative electrode, and a separator interposed between the positive and negative electrodes, a case accommodating the electrode assembly, and an electrode terminal electrically connected to the electrode assembly. An electrolyte solution is injected into the case to enable charging and discharging of the battery via an electrochemical reaction of the positive electrode, the negative electrode, and the electrolyte solution. The shape of the case, such as a cylindrical or rectangular shape, may be selected based on the battery's intended purpose. Lithium-ion (and similar lithium polymer) batteries, which are used in laptops and consumer electronics, are predominantly used in the most recent group of electric vehicles in development.

Rechargeable batteries may be used as a battery module formed of a plurality of unit battery cells coupled to each other in series and/or in parallel to provide relatively high energy density, such as for motor driving of a hybrid vehicle. For example, the battery module may be formed by interconnecting the electrode terminals of the plurality of unit battery cells in an arrangement and/or configuration depending on a desired amount of power and to realize a relatively high-power rechargeable battery.

Battery modules can be constructed in either a block design or in a modular design. In the block design, each battery is coupled to a common current collector structure and a common battery management system, and the unit thereof is accommodated in a housing. In the modular design, pluralities of battery cells are connected together to form submodules, and several submodules are connected together to form the battery module. In automotive applications, battery systems may include a plurality of battery modules connected together in series to provide a desired voltage. The battery modules may include submodules with a plurality of stacked battery cells, and each stack includes cells connected in parallel that are, in turn, connected in series (XpYs) or cells connected in series that are, in turn, connected in parallel (XsYp).

A battery pack is a set of any number of (usually identical) battery modules. The battery modules may be configured in a series, parallel, or a mixture of both to deliver the desired voltage, capacity, and/or power density. Components of a battery pack include the individual battery modules and interconnects, which provide electrical conductivity between the battery modules.

Exothermic decomposition of cell components may lead to a thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive or a problematic result. In rechargeable battery systems, thermal runaway is associated with relatively strong exothermic reactions that are accelerated by temperature rise. These exothermic reactions include combustion of flammable gas compositions within the battery pack housing. For example, when a cell is heated above a critical temperature (for example, above 150° C.) the cell can transition into a thermal runaway. The initial heating may be caused by a local failure, such as a cell internal short circuit, heating from a defective electrical contact, a short circuit to an adjacent cell, and/or the like. During the thermal runaway, a failed battery cell (e.g., a battery cell that has a local failure) may reach a temperature exceeding about 700° C. Further, large quantities of hot gas are ejected from inside of the failed battery cell through the venting opening of the cell housing into the battery pack. The main components of the vented gas are H₂, CO₂, CO, electrolyte vapor and other hydrocarbons. The vented gas is therefore flammable and potentially toxic. The vented gas also causes a gas-pressure to increase inside the battery pack.

One conventional a battery module includes a plurality of battery cells that are arranged in the form of a stack of battery cells. The battery cells are, for example, rechargeable lithium ion battery cells or lithium polymer battery cells. The stack of battery cells is enclosed at its outer face by a mechanical bracing device. On the one hand, this approach provides stationary fixing of the battery cells of the stack of battery cells relative to adjacent battery cells and prevents an excessive increase in the volume of the battery cells when in operation, as a result of the electrochemical processes inside the battery cells.

Another conventional battery module for a traction battery of an electrically driven motor vehicle has a cell assembly including cylindrical cells. An outside of the cell assembly is enclosed by cell housing areas positioned at the edge in the cell assembly. The battery module further includes a protective device, which is designed to protect at least two cells arranged adjacent to one another in the cell assembly from an accident-related force and to prevent thermal propagation between the at least two adjacent cells. The protective device has at least one force protection area, which at least partially overlaps with the outside of the cell assembly on the at least two adjacent cells. The protection device has at least one force protection area mechanically connected to a heat protection area, which is arranged between two adjacent round cells for thermal insulation of the two adjacent round cells.

However, in actual pack designs, when a cell goes to thermal runaway, the generated heat spreads through the cell to cell spacers and accumulates in adjacent cells of the battery pack. This may trigger a thermal runaway of the adjacent cell(s). Thermal propagation in this way develops and may lead to catastrophic burndown of the battery pack.

### SUMMARY

The present disclosure is defined by the appended claims and their equivalents. The description that follows is subject to this limitation. Any disclosure lying outside the scope of the claims and their equivalents is intended for illustrative as well as comparative purposes.

According to one or more embodiments of the present disclosure, a battery system may include a battery cell stack including a plurality of battery cells and a plurality of thermally isolating cell spacers between the plurality of battery cells, and a heat transfer unit on at least one side of the battery cell stack, the heat transfer unit including a first heat transfer element and a second heat transfer element, the first heat transfer element and the second heat transfer element are thermally isolated from each other, wherein the first heat transfer element contacts (e.g., establish a thermally conductive contact) at least one of battery cells in an even row of the battery cell stack and the second heat transfer element contacts (e.g., establish a thermally conductive contact) at least one of battery cells in an odd row of the battery cell stack.

According to one or more embodiments of the present disclosure, a heat transfer unit for a battery system may include two heat transfer elements separated from each other by a thermal isolation layer, wherein each heat transfer elements includes a shaft that holds a plurality of contact faces arranged on both sides (e.g., opposite sides) of the shaft and forming two rows of contact faces with regular intervals between the contact faces.

According to one or more embodiments of the present disclosure, a method for assembling a battery system may include: connecting the battery cells of the battery cell stack of the battery system to the heat transfer unit. The heat transfer unit includes a first heat transfer element and a second heat transfer element. Each of the two heat transfer elements is arranged such that the first heat transfer element contacts at least one of battery cells arranged in an even row of the battery cell stack and the second heat transfer element contacts at least one of the battery cells arranged in an odd row of the battery cell stack. Heat is transferred from a heated battery cell of one of the battery cell stacks via the heat transfer unit until the temperature of the heated battery cell is less than a critical temperature (e.g., temperature which leads to thermal runaway of a battery cell adjacent to the heated battery cell).

Further embodiments of the present disclosure will be discussed in more detail.

### BRIEF DESCRIPTION OF THE DRAWINGS

The following drawings attached hereto illustrate embodiments of the present disclosure and are intended to provide a further understanding of the technical spirit of the present disclosure along with the detailed description of the present disclosure. Thus, the present disclosure should not be construed as being limited to the embodiments as illustrated in the drawings. In the drawings:

FIG. 1 is a schematic view of a battery system.

FIG. 2 is a schematic view of a battery system according to one or more embodiments.

FIG. 3 is a heat transfer unit according to one or more embodiments.

FIG. 4 is a flowchart describing a process for transferring heat of a heated battery cell within a battery system according to one or more embodiments.

### DETAILED DESCRIPTION

Reference will now be made in more detail to one or more embodiments, examples of which are illustrated in the accompanying drawings. Aspects and features of the embodiments, and implementation methods thereof, will be described in more detail with reference to the accompanying drawings. In the drawings, like reference numerals denote like elements, and redundant descriptions may not be provided. The present disclosure, however, may be embodied in one or more suitable different forms and should not be construed as being limited to only the illustrated embodiments herein. Rather, these embodiments are provided as examples so that this disclosure will be thorough and complete and will fully convey the aspects and features of the present disclosure to those skilled in the art.

Accordingly, processes, elements, and techniques that are not considered necessary to those having ordinary skill in the art for a complete understanding of the aspects and features of the present disclosure may not be described or may be only briefly described. In the drawings, the relative sizes of elements, layers, and regions may be exaggerated for clarity.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

The reference to two objects of comparison being “the same” means “substantially the same”. Therefore, “the same” or “substantially the same” may include a deviation that is considered as a low level in the art, for example, a deviation of less than 5%. In addition, uniformity of a parameter at a certain area may mean uniformity from an average perspective.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Embodiments of the present disclosure are directed to a battery system including a plurality of battery cells arranged in at least one battery cell stack with thermally isolating cell spacers positioned between the battery cells and a heat transfer unit on (e.g., disposed on) at least one side of the battery cell stack. The heat transfer unit includes a first heat transfer element and a second heat transfer element, and the first heat transfer element and the second heat transfer element are thermally isolated from each other.

The first heat transfer element is configured to contact (e.g., establish a thermally conductive contact) at least one of the battery cells arranged in an even row of the at least one battery cell stack and the second heat transfer element is configured to contact (e.g., establish a thermally conductive contact) at least one of the battery cells arranged in an odd row of the at least one battery cell stack.

For example, embodiments of the present disclosure provide a battery cell stack with a plurality of battery cells, each of which is separated from an adjacent cell by a thermally isolating cell spacer. The battery cells are connected to (e.g., have a thermally conductive connection with) a heat transfer unit to dissipate heat from a heated battery cell and reduce or minimize heat transfer to adjacent cells (e.g., immediately adjacent cells) of the heated battery cell.

The heat transfer unit conducts the heat of a heated battery cell, e.g. in case of a malfunction of a battery cell, so that the thermal impact to the adjacent battery cells (e.g., immediately adjacent battery cells) of the heated battery cell is minimized. This protects the whole battery cell stack from a thermal runaway and a chain reaction that could lead to a burn down of the battery system. If the heat is transferred to regions of the battery cell stack not directly adjacent to the heated battery cell, such a thermal runaway can be prevented or reduced so that only the heated battery cell with the malfunction is affected. This does not only improve the safety of the battery cell, but also makes it possible and cost effective to repair a battery system by simply changing the one affected battery cell.

In one or more embodiments of the battery system, the battery system includes at least a first battery cell stack including a plurality of battery cells accommodated within the first battery cell stack and a second battery cell stack including a plurality of battery cells accommodated within the second battery cell stack arranged in parallel to the first battery cell stack. Each of the battery cell stacks includes thermally isolating cell spacers positioned between the battery cells of the battery cell stack. A heat transfer unit is arranged between the first battery cell stack and the second battery cell stack and includes two heat transfer elements (e.g., a first heat transfer element and a second heat transfer element), the two heat transfer elements being thermally isolated from each other and nested inside each other, wherein each of the two heat transfer elements is arranged such that a first heat transfer element of the two heat transfer elements contacts at least one of battery cells arranged in an even row of the two battery cell stacks and a second heat transfer element of the two transfer elements contacts at least one of battery cells arranged in an odd row of the two battery cell stacks.

For example, one or more embodiments of the present disclosure are related to a battery system including at least two battery cell stacks arranged in parallel, wherein each of the battery cell stacks includes a plurality of battery cells and thermally isolating cell spacers. The battery cells and thermally isolating cell spacers are alternately stacked along their sides. The battery system includes a heat transfer unit (or a heat spreader or heat dissipating member) which is arranged between and extends along the two battery cell stacks. The heat transfer unit includes two heat transfer elements (or heat spreaders) having a comb shape, the two heat transfer elements (or heat spreaders) being thermally isolated from each other and nested inside each other. Each of the two heat spreaders is arranged such that it contacts battery cells of the two cell stacks.

The heat transfer unit spreads or dissipates heat of a battery cell in case of a thermal runaway to any battery cell, e. g., battery cells arranged in even or odd rows of the cell stack but not to adjacent cells within the same cell stack. Thereby, on the one hand, heat of the affected cell is conducted away, while on the other hand the heat is not conducted into the adjacent cells, which are heated to some degree via the imperfectly isolating cell spacers. This allows the temperature of the adjacent cells of the same cell stack of the high temperature cell to be below a critical temperature and thus prevents the adjacent cells from heating up to such an extent that a chain reaction occurs and the complete battery system is destroyed or damaged by a thermal runaway.

According to one or more embodiments of the present disclosure, the first heat transfer element and the second heat transfer element of the heat transfer unit are arranged in a comb structure including a shaft that holds a row of contact faces. The comb structure allows a compact and smart design of the heat transfer unit, such that battery cells arranged in even or odd rows of each battery cell stack can be either connected to the first heat transfer element or the second heat transfer element of the heat transfer unit. This makes it easier to dissipate heat from a heated battery cell and minimize heat transfer to adjacent battery cells (e.g., immediately adjacent battery cells) of the heated battery cell.

According to one or more embodiments of the present disclosure, the first heat transfer element and the second heat transfer element of the heat transfer unit include (e.g., are made of) a material that has a higher thermal conductivity than a battery cell housing of the battery cell. A higher thermal conductivity is advantageous to transfer the heat from the heated battery cell. To avoid or reduce a thermal runaway of the adjacent cells within the battery stack it is beneficial that the heat transfer elements of the heat transfer unit have a higher thermal conductivity than the battery cell housings of the battery cells to decrease the heat transfer via the thermally isolating cell spacer of a battery cell stack.

The heat transfer elements may include (e.g., be made of) copper. Copper does not only provide a high thermal conductivity, but also a high melting point, so that the heat transfer element remains dimensionally stable and can dissipate heat even if a battery cell is thermally punctured.

According to one or more embodiments of the present disclosure, a thermal isolation layer is arranged between the first heat transfer element and the second heat transfer element of the heat transfer unit. The thermal isolation layer is beneficial to avoid or reduce heat transfer to an adjacent battery cell of a heated battery cell. The thermal isolation layer allows for the transfer of heat mainly to battery cells arranged in even or odd rows of a battery cell stack, so that the adjacent battery cells of heated battery cells are at least not heated by high thermal conductivity, but only by radiation, so that a critical thermal load for the adjacent battery cells of the heated battery cell can be avoided or reduced.

The thermal isolation layer may include (e.g., be made of) a plastic coating or a ceramic coating. A plastic coating or a ceramic coating can be applied to the heat transfer unit easily and with little cost. Furthermore, such a plastic or ceramic coat can provide a high thermal isolation between the two heat transfer elements of the heat transfer unit. While a ceramic coating can probably withstand the high temperatures such as those encountered during thermal failure of a battery cell, e.g. a thermal runaway of one battery cell of a battery cell stack, the plastic coating may melt, but may still provide sufficient thermal isolation to avoid or reduce a significant heat transfer to the adjacent battery cell.

In one or more embodiments of the present disclosure, the thermal isolation layer includes (e.g., is made of) glass fiber material. Glass fiber material can be used as thermically and electrically isolation in printed circuits. A glass fiber material is also suitable to separate the first heat transfer element from the second heat transfer element of the heat transfer unit.

According to one or more embodiments of the present disclosure, the heat transfer unit is designed as a hollow body. A heat transfer unit with a hollow body may be desirable, as the hollow body reduces the weight of the battery system. Furthermore, a hollow body has a lower heat capacity and can therefore dissipate the heat from the heated battery cell more quickly.

In one or more embodiments of the present disclosure, the battery cells of each battery cell stack are connected to the heat transfer unit via a side surface of a battery cell housing of the battery cell. The battery cell housing of a battery cell has a front surface, a back surface and two side surfaces. The front surface and the back surface extend wider than the side surface, such that a prismatic battery cell has a shorter side with a side surface and a longer side with either the front surface or the back surface. The connecting of the battery cell housing of the battery cell to the heat transfer unit via the side surface allows a compact battery system with high energy density and low installation space requirements.

According to one or more embodiments of the present disclosure, the battery cells are prismatic battery cells. Prismatic battery cells can be assembled in parallel stacks, so that the heat can be transferred from the prismatic battery cells. The heat transfer unit could also be used for round cells with an adapted design, so that adjacent battery cells are connected to different heat transfer elements of the heat transfer unit.

One or more embodiments of the present disclosure are related to a heat transfer unit for a battery system, including two heat transfer elements separated from each other by a thermal isolation layer, wherein each heat transfer element includes a shaft that holds a plurality of contact faces arranged on both sides (e.g., opposite sides) of the shaft and forming two rows of contact faces with regular intervals between the contact faces. The heat transfer unit conducts the heat of a heated battery cell, e.g. in case of a malfunction of a battery cell, so that the thermal impact to the adjacent battery cells (e.g., immediately adjacent battery cells) of the heated battery cell is minimized or reduced. This protects the whole battery cell stack from a thermal runaway and a chain reaction that could lead to a burn down of the battery system. If the heat is transferred to regions of the battery cell stack not directly adjacent to the heated battery cell, such a thermal runaway can be prevented or reduced so that only the heated battery cell with the malfunction is affected. This does not only improve the safety of the battery cell, but also makes it possible and cost effective to repair a battery system by simply changing the one affected battery cell.

In one or more embodiments of the present disclosure, the heat transfer unit includes two heat transfer elements thermally isolated from each other and nested inside each other. Each of the two heat transfer elements is designed such that the first heat transfer element contacts battery cells arranged in even rows of the two battery cell stacks and the second heat transfer element contacts battery cells arranged in odd rows of the two battery cell stacks, when the heat transfer unit is inserted into a battery system.

According to one or more embodiments of the heat transfer unit, the contact faces extend perpendicular to the shaft, wherein the contact faces include a first portion and a second portion, the second portion being perpendicular to the first portion and the contact faces of at least one side of the shaft being opposite (e.g., directly opposite) to the contact faces of the other side of the shaft. This allows for an easier thermal conductive connection between the side faces of the battery cell housing and the heat transfer unit and reduces the heat to the adjacent battery cells (e.g., immediately adjacent battery cells) of the heated battery cell as the heat dissipation from a heated battery cell is improved.

In one or more embodiments of the present disclosure, the first heat transfer element and the second heat transfer element of the heat transfer unit are stamped and bent parts. Stamped and bent parts are easy to manufacture at low rates. Furthermore, stamped and bent parts can be manufactured from a coil material, which allows for mass production in a simple way.

In one or more embodiments of the present disclosure, a thermal isolation layer is formed between the first heat transfer element and the second heat transfer element of the heat transfer unit. The thermal isolation layer can be formed in a coating process on either one or both heat transfer elements of the heat transfer unit. The thermal isolation layer can also be formed by an injection molding process on either one or both heat transfer elements of the heat transfer unit. In an example, the two heat transfer elements are connected to each other by an injection molding process, forming a plastic insulation element between the first heat transfer element and the second heat transfer element of the heat transfer unit.

### Specific Embodiments

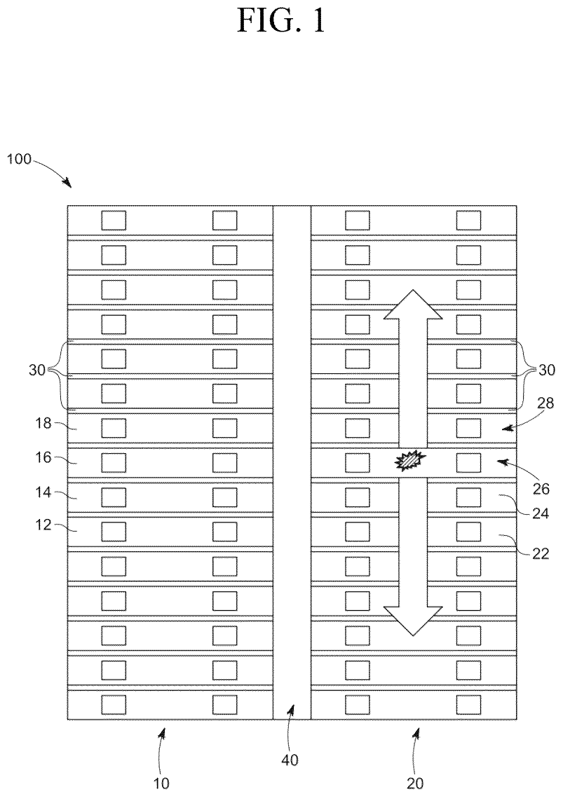

FIG. 1 is a schematic view of a battery system 100. The battery system 100 includes a first cell stack 10 with a plurality of battery cells 12, 14, 16, 18 and a second battery stack 20 with another plurality of battery cells 22, 24, 26, 28, wherein the first battery cell stack 10 and the second battery cell stack 20 are arranged in parallel. There are thermally isolating cell spacers 30 arranged in the first cell stack 10 and in the second cell stack 20 between each battery cell 12, 14, 16, 18, 22, 24, 26, 28 of the battery cell stacks 10, 20. FIG. 1 shows a battery cell 26 of the second cell stack 20 which, due to a malfunction, heats up to such an extent that it is irreversibly damaged. A heat transfer unit 40 is arranged between the first cell stack 10 and the second cell stack 20 to be able to dissipate the heat of the heated battery cell 26 from the second cell stack 20.

However, the thermal conductivity of the heat transfer unit 40 in this case is not sufficiently large to be able to be used in a thermal runaway to protect the adjacent cells 24, 28 of the heated battery cell 26. Also, the thermal isolating cell spacer 30 does not withstand the thermal load, such that the generated heat of the heated battery cell 26 spreads through the thermal isolating cell spacers 30 and accumulates in the adjacent cells 24, 28, where the heat triggers a thermal runaway of the adjacent cells 24, 28. Thermal propagation in this way develops and leads to a burndown of the whole battery system 100 or at least the affected battery cell stack 20.

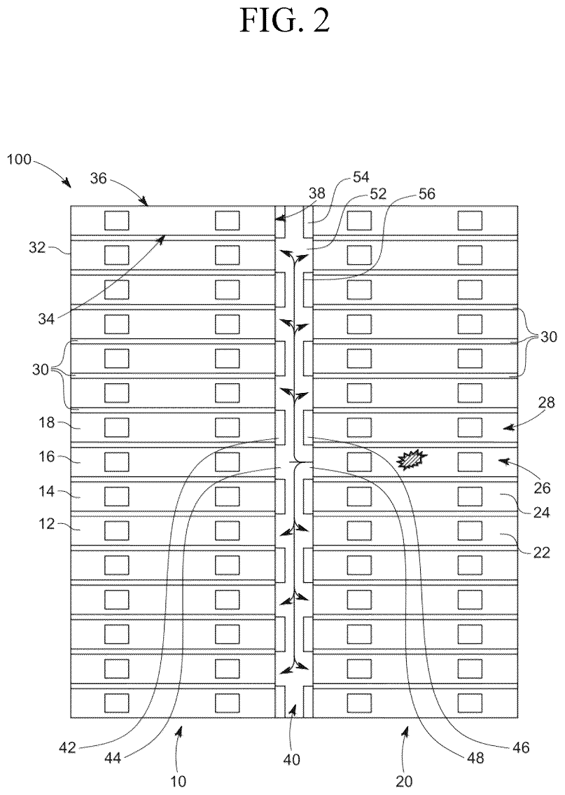

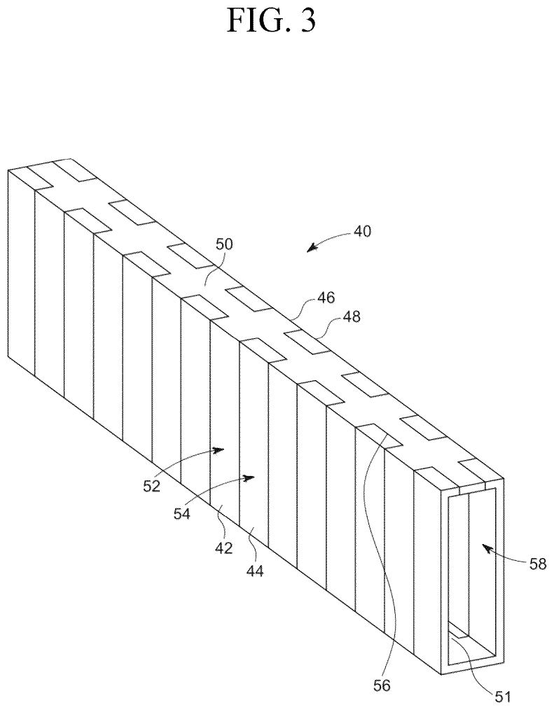

FIG. 2 discloses an example of a battery system 100 according to the present disclosure. The battery system 100 includes a first battery cell stack 10 including a plurality of battery cells 12, 14, 16, 18 accommodated within the first battery cell stack 10 and a second battery cell stack 20 including a plurality of battery cells 22, 24, 26, 28 accommodated within the second battery cell stack 20 arranged in parallel to the first battery cell stack 10. Each of the battery cell stacks 10, 20 includes thermally isolating cell spacers 30 positioned between a front surface 34 of a cell housing 32 of each battery cells 12, 14, 16, 18, 22, 24, 26, 28 and a back surface 36 of a cell housing 32 of an adjacent battery cells 12, 14, 16, 18, 22, 24, 26, 28. A heat transfer unit 40 is arranged between the first battery cell stack 10 and the second battery cell stack 20. Referring to FIG. 3, the heat transfer unit 40 has a comb structure 50 and includes two heat transfer elements 52, 54, thermally isolated from each other by a thermal isolation layer 56 and nested inside each other. The heat transfer unit 40 has a plurality of contact surfaces 42, 44, 46, 48. The contact surfaces 42, 44, 46, 48 are designed to connect the heat transfer unit 40 to side surfaces 38 of the cell housing 32 of the battery cells 12, 14, 16, 18, 22, 24, 26, 28 in the battery cell stacks 10, 20 to dissipate the heat generated in the battery cells 12, 14, 16, 18, 22, 24, 26, 28. Each of the two heat transfer elements 52, 54 is arranged such that the first heat transfer element 52 contacts at least one of battery cells 12, 16, 22, 26 arranged in an even row of the two battery cell stacks 10, 20 and the second heat transfer element 54 contacts at least one of battery cells 14, 18, 24, 28 arranged in an odd row of the two battery cell stacks 10, 20. For example, the first heat transfer element 52 contacts battery cells 12, 16, 22, 26 arranged in every even row of the two battery cell stacks 10, 20 and the second heat transfer element 54 contacts other battery cells 14, 18, 24, 28 arranged in every odd row of the two battery cell stacks 10, 20.

The heat transfer unit 40 has the thermal isolation layer 56 arranged between the first and second heat transfer elements 52, 54, such that a heat transfer from the first heat transfer element 52 to the second heat transfer element 54 of the heat transfer unit is minimized. The thermal isolation layer 56 may be designed as a plastic coating, a ceramic coating, a glass fiber material or similar thermally non-conducting material. In one or more embodiments, a design of the heat transfer unit 40 may be desirable as a hollow body 58 to reduce the weight of the battery system 100. Furthermore, the hollow body 58 has a lower heat capacity and can therefore dissipate the heat from the heated battery cell 26 more quickly. The heat transfer elements 52, 54 of the heat transfer unit 40 may include (e.g., be made of) a material with a high thermal conductivity that can withstand temperatures of more than 800° C. without losing its structure. A material of the heat transfer elements 52, 54 may be, for example, copper.

FIG. 2 shows an example of a heat spread within a battery system 100 according to the present disclosure, when a battery cell 26 is heated by a malfunction. The heat transfer unit 40 spreads the heat generated by the heated battery cell 26 in a cell thermal runaway to battery cells arranged in every even row of the two battery cell stacks 10, 20, but not to the adjacent battery cells 24, 28 divided from the heated battery cell 26 only by means of the thermally isolating cell spacers 30. The heat transfer unit 40 in combination with the thermally isolating cell spacers 30 minimizes the heat flow into the adjacent cells 24, 28, such that a thermal runaway of the adjacent battery cells 24, 28 is not triggered and a chain reaction can be prevented or reduced. In this way the heating of the adjacent cells can by kept under a critical threshold value to prevent or reduce the thermal runaway of the adjacent battery cells 24, 28.

FIG. 3 discloses a heat transfer unit 40 according to the present disclosure. The heat transfer unit 40 has a comb-like structure with two different heat transfer elements 52, 54 separated from each other by a thermal isolation layer 56 and nested inside each other. Each heat transfer element 52, 54 includes a shaft 50, 51 that holds a row of contact faces 42, 44, 46, 48, which extend perpendicular to the shaft 50, 51. The contact faces 42, 44, 46, 48 include a first portion and a second portion, the second portion being perpendicular to the first portion, such that the contact faces 42, 44 of one side of the shaft 50 being opposite (e.g., directly opposite) to the contact faces 46, 48 of the other side of the shaft 51. The contact surfaces 42, 44, 46, 48 are arranged at regular intervals on the left and right sides of the shaft 50, forming two rows. The contact faces 42, 44 on one side of the shaft 50 can be opposite (e.g., directly opposite) the contact faces 46, 48 on the other side of the shaft 51 as shown in FIG. 3 or they are arranged offset to each other. The two heat transfer elements 52, 54 can be similar or identical. The heat transfer elements 52, 54 can be manufactured as stamped and bent parts, wherein the contact faces 42, 44, 46, 48 are bent after the stamping process. The two heat transfer elements 52, 54 having comb-like structure respectively, can be plugged together to form an elongated hollow body 58.

In principle, material thickness and integration of the heat transfer unit 40 into the battery system 100 is based on battery pack design. The heat transfer unit 40 has a plurality of contact surfaces 42, 44, 46, 48. The contact surfaces 42, 44, 46, 48 are designed to connect the heat transfer unit 40 to side surfaces 38 of the cell housing 32 of the battery cells 12, 14, 16, 18, 22, 24, 26, 28 in the battery stacks 10, 20 to dissipate the heat generated in the battery cells 12, 14, 16, 18, 22, 24, 26, 28. The size of the contact surfaces 42, 44, 46, 48 is determined by the size of the side surface 38 of the cell housing 32 and can be the same.

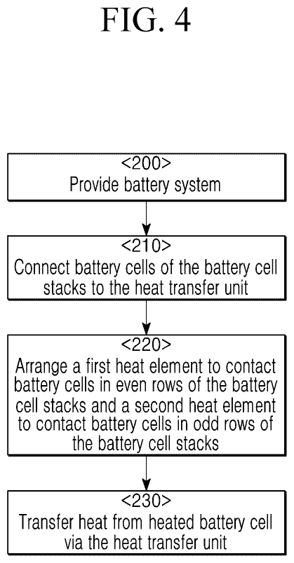

FIG. 4 shows a flowchart of a process according to the present disclosure for transferring heat of a heated battery cell 26 within a battery system 100. The battery cell 26 may be heated up by a malfunction. A heated battery cell is a battery cell whose temperature is above (e.g., far above) the normal operating temperature or in which a thermal runaway is already taking place. In a first step <200> a battery system as described in the previous sections is provided. In a second step <210> of the method, the battery cells 12, 14, 16, 18, 22, 24, 26, 28 of the two parallel battery cell stacks 10, 20 are connected to the heat transfer unit 40. In a third step <220> the two heat transfer elements 52, 54 are arranged such that the first heat transfer element 52 contacts at least one of battery cells 12, 16, 22, 26 arranged in an even row of the two battery cell stacks 10, 20 and the second heat transfer element 54 contacts at least one of battery cells 14, 18, 24, 28 arranged in an odd row of the two battery cell stacks 10, 20 conducting heat from the heated battery cell 26 of the battery cell stacks 10, 20 via the heat transfer unit 40. In a fourth step <230> heat from a heated battery cell 26 of one of the battery cell stacks 10, 20 is transferred via the heat transfer elements 52, 54, such that a critical temperature which leads to thermal runaway of a battery cell 24, 28 adjacent to the heated battery cell 26 is not exceeded (e.g., the temperature of the heated battery cell is less than a critical temperature).

Aspects and features of the present disclosure are not limited to the above-described aspects and features, and other aspects and features not mentioned herein can be clearly understood by those skilled in the art from the description of the present disclosure and the following claims.

Although embodiments have been disclosed herein, and specific terms employed, they are used and are to be interpreted in a generic and descriptive sense and not for purpose of limitation. Accordingly, it will be understood by those of ordinary skill in the art that various changes in form and details may be made without departing from the spirit and scope of the present disclosure as set forth in the following claims and their equivalents.

### REFERENCE SIGNS

10 first battery cell stack
12 first battery cell
14 second battery cell
16 third battery cell
18 fourth battery cell
20 second battery cell stack
22 fifth battery cell
24 sixth battery cell
26 seventh battery cell
28 eighth battery cell
30 thermally isolating cell spacer
32 cell housing
34 front surface
36 back surface
38 side surface
40 heat transfer unit
42 first contact surface
44 second contact surface
46 third contact surface
48 fourth contact surface
50, 51 shaft
52 first heat transfer element
54 second heat transfer element
56 thermal isolation layer
58 hollow body
100 battery system

What is claimed is:

1. A battery system comprising:
a battery cell stack comprising a plurality of battery cells and a plurality of thermally isolating cell spacers between the plurality of battery cells; and
a heat transfer unit on at least one side of the battery cell stack, the heat transfer unit comprising a first heat transfer element and a second heat transfer element,
wherein the first heat transfer element and the second heat transfer element are thermally isolated from each other,
wherein the first heat transfer element contacts at least one of the plurality of battery cells in an even row of the battery cell stack, and the second heat transfer element contacts at least one of the plurality of battery cells in an odd row of the battery cell stack.

2. The battery system as claimed in claim 1, wherein the battery cell stack comprises a first battery cell stack and a second battery cell stack in parallel to the first cell stack,
wherein the heat transfer unit is between the first battery cell stack and the second battery cell stack,
wherein the first heat transfer element contacts battery cells in every even row of the first and second battery cell stacks and the second heat transfer element contacts battery cells in every odd row of the first and second battery cell stacks.

3. The battery system as claimed in claim 1, wherein the first heat transfer element and the second heat transfer element are each in a comb structure comprising a shaft that holds a row of contact faces.

4. The battery system as claimed in claim 1, wherein the first heat transfer element and the second heat transfer element each comprise a material having a higher thermal conductivity than a battery cell housing of the plurality of battery cells.

5. The battery system as claimed in claim 1, wherein the first heat transfer element and/or the second heat transfer element comprises copper.

6. The battery system as claimed in claim 1, wherein a thermal isolation layer is between the first heat transfer element and the second heat transfer element.

7. The battery system as claimed in claim 6, wherein the thermal isolation layer comprises a plastic coating or a ceramic coating or a glass fiber material.

8. The battery system as claimed in claim 1, wherein the heat transfer unit comprises a hollow body.

9. The battery system as claimed in claim 1, wherein the plurality of battery cells of the battery cell stack is connected to the heat transfer unit via a side surface of a cell housing.

10. The battery system as claimed in claim 1, wherein the plurality of battery cells comprises prismatic battery cells.

11. A heat transfer unit for a battery system comprising a first heat transfer element and a second heat transfer element, the first heat transfer element and the second heat transfer element being separated from each other by a thermal isolation layer,
wherein each of the first and second heat transfer elements comprises a shaft that holds a plurality of contact faces on opposite sides of the shaft and forming two rows of contact faces with regular intervals between the contact faces.

12. The heat transfer unit as claimed in claim 11, wherein the contact faces extend perpendicular to the shaft, wherein the contact faces comprise a first portion and a second portion, the second portion being perpendicular to the first portion and the contact faces of one side of the shaft being opposite to the contact faces of the other side.

13. The heat transfer unit as claimed in claim 11, wherein the first heat transfer element and the second heat transfer element comprise stamped and bent parts.

14. A method for assembling a battery system as claimed in claim 1, the method comprising:
connecting the plurality of battery cells of the battery cell stack to the heat transfer unit, wherein each of the first and second heat transfer elements is arranged such that the first heat transfer element contacts at least one of the plurality of battery cells in an even row of the battery cell stack and the second heat transfer element contacts at least one of the plurality of battery cells in an odd row of the battery cell stack, and
wherein heat is transferred from a heated battery cell of one of the battery cell stacks via the heat transfer unit until a temperature of the heated battery cell is less than a critical temperature.
